(19) United States
(12) Patent Application Publication
(10) Pub. No.: US 2003/0237088 A1
(43) Pub. Date: Dec. 25, 2003

(54) Use of two remote controllers in parental control

(75) Inventors: Douglas B. Macrae, Weston, MA (US); Wing P. Leung, Arcadia, CA (US); Henry C. Yuen, Pasadena, CA (US); Andrew Duncan, Santa Monica, CA (US)

Correspondence Address: CHRISTIE, PARKER & HALE, LLP, P.O. BOX 7068, PASADENA, CA, 91109-7068, US

(73) Assignee: Gemstar Development Corporation

(21) Appl. No.: 10/419,615

(22) Filed: Apr. 21, 2003

Related U.S. Application Data
(63) Continuation of application No. 09/240,170, filed on Jan. 29, 1999, now abandoned.
(60) Provisional application No. 60/073,145, filed on Jan. 30, 1998.

(51) Int. Cl. H04N 7/16

(52) U.S. Cl. 725/25

(57) ABSTRACT

A television control system automatically tunes a television set to receive and display a desired program telecast at a future time. This is done by keying in a PLUS CODE™ number defining the channel, time, day, and length (CTDL data) of the program or selecting the program from an on-screen program guide to capture the CTDL data from an EPG data base stored in memory. The CTDL data is stored in a stack memory until the time of the program. The microprocessor monitors the stack memory. The microprocessor tunes the television set to the channel on which the desired program is telecast and turns the television set on at the time of the desired program.

If the television set is already on at the time of the desired program, the television set is not turned off at the conclusion of the desired program, i.e., it remains on. However, if the television set is off at the time of the desired program, the television set is turned off again at the conclusion of the desired program. This results in the television set not being left on when the residents are away from home while the scheduled tuning feature is being used.

### CROSS-REFERENCE TO RELATED APPLICATIONS

This application is a continuation of co-pending Application Ser. No. 09/240,170, filed on Jan. 29, 1999, which claims the benefit of U.S. Application No. 60/073,145 filed Jan. 30, 1998, the disclosures of which are incorporated fully herein by reference.

The disclosures of the following applications are also incorporated fully herein by reference: Provisional Application No. 60/014,512 filed Apr. 1, 1996 entitled “User Programmable V-Chip System”; Provisional Application No. 60/022,210 filed Jul. 18, 1996 entitled “Parental Control Method and Apparatus”; Provisional Application No. 60/023,724 filed Aug. 8, 1996 entitled “Parental Control for Cable Input”; regular application Ser. No. 08/831,531 filed Apr. 1, 1997 entitled “Parental Control”; and regular application Ser. No. 08/584,578 filed Jul. 19, 1996 entitled “Improved Apparatus and Method for Use in Parental Control.”

### SUMMARY OF THE INVENTION

A television control system automatically tunes a television set to receive and display a desired program telecast at a future time. This is done by keying in a PLUS CODE™ number defining the channel, time, day, and length (CTDL data) of the program or selecting the program from an on-screen program guide to capture the CTDL data from an EPG data base stored in memory. The CTDL data is stored in a stack memory until the time of the program. The microprocessor monitors the stack memory. The microprocessor tunes the television set to the channel on which the desired program is telecast and turns the television set on at the time of the desired program.

If the television set is already on at the time of the desired program, the television set is not turned off at the conclusion of the desired program, i.e., it remains on. However, if the television set is off at the time of the desired program, the television set is turned off again at the conclusion of the desired program. This results in the television set not being left on when the residents are away from home while the scheduled tuning feature is being used.

### DESCRIPTION OF THE DRAWINGS

The features of specific embodiments of the best mode contemplated of carrying out the invention are illustrated in the drawings, in which:

FIG. 1 is a block diagram of a television system according to an embodiment of the invention; and

FIG. 2 is a flow diagram of the operation of a television system according to an embodiment of the invention.

### DETAILED DESCRIPTION OF A SPECIFIC EMBODIMENT

The described embodiment of the invention is only considered to be preferred and illustrative of the inventive concept; the scope of the invention is not to be restricted to such embodiment. Various and numerous other arrangements may be devised by one skilled in the art without departing from the spirit and scope of this invention. For example,

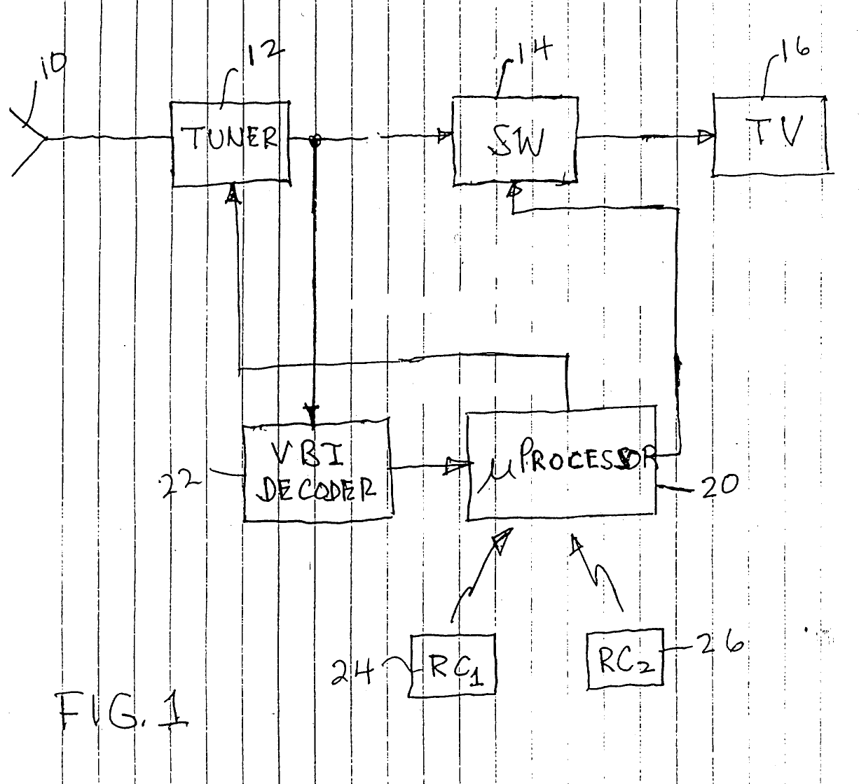

In FIG. 1, a telecast television signal is coupled by a cable feed 10, other signal distribution means, or over-the-air antenna to a frequency converter and tuner 12, which selects a desired channel of the television signal for viewing. Parental control ratings are embedded in the VBI of the television signal. The output of tuner 12 is connected by a switch (SW) 14 to a television monitor (TV) 16. Switch 14 is controlled by a microprocessor 20 that includes ROM and RAM memories and a real time clock not shown. The output of tuner 12 is also fed to a VBI decoder 22, which recovers the ratings from the television signal and couples them to microprocessor 20. What has been described to this point is a conventional parental control system.

An unrestricted remote control unit (RC₁) 24 and a restricted remote control unit (RC₂) 26 transmit commands to microprocessor 20, preferably by means of an IR signal. As described in detail below, restricted remote control unit 26 is limited in the commands it can issue in accordance with parental control guidelines imposed by commands issued by unrestricted remote control unit 24. Common commands, such as for example channel changing commands, from remote controllers 24 and 26 comprise a series of IR bursts having different preambles that are recognizable by microprocessor 20 so they are executed by microprocessor, or not executed, depending upon the controller that issued the command. In addition, to enable unrestricted control unit 24 to perform unique functions denied to restricted control unit 26, unrestricted control unit 24 has more function keys than restricted control unit 26 to issue corresponding unique commands.

In operation, a person in possession of unrestricted remote control unit 24, normally a parent or an adult, sends a unique command to microprocessor 20 to establish a desired parental control level, e.g., PG-13, preferably by means of a key not provided on restricted control unit 26. Microprocessor 20 accepts and stores the desired level in RAM. VBI decoder 22 continuously strips from the VBI of the television signal the rating assigned to the program on the channel to which tuner 12 is set. The assigned rating of the program on the selected channel is continuously compared to the desired level.

When a channel changing command is issued by unrestricted control unit 24 or restricted control unit 26, microprocessor 20 sets tuner 12 accordingly. The assigned rating is detected by decoder 22. If the assigned rating is less objectionable than the desired level, microprocessor 20 closes switch 14 to send the signal on the selected channel to monitor 16, regardless of which controller issued the channel changing command. If the assigned rating is more objectionable than the desired level, microprocessor 20 only closes switch 14 to send the signal on the selected channel to monitor 16, if it senses that the preamble of unrestricted control unit 24 issued the channel changing command.

In an alternative embodiment, microprocessor 20 is configured so tuner 12 does not change channels or otherwise respond if restricted control unit 26 issues a command that violates the parental control standards. In this case, switch 14 is not needed.

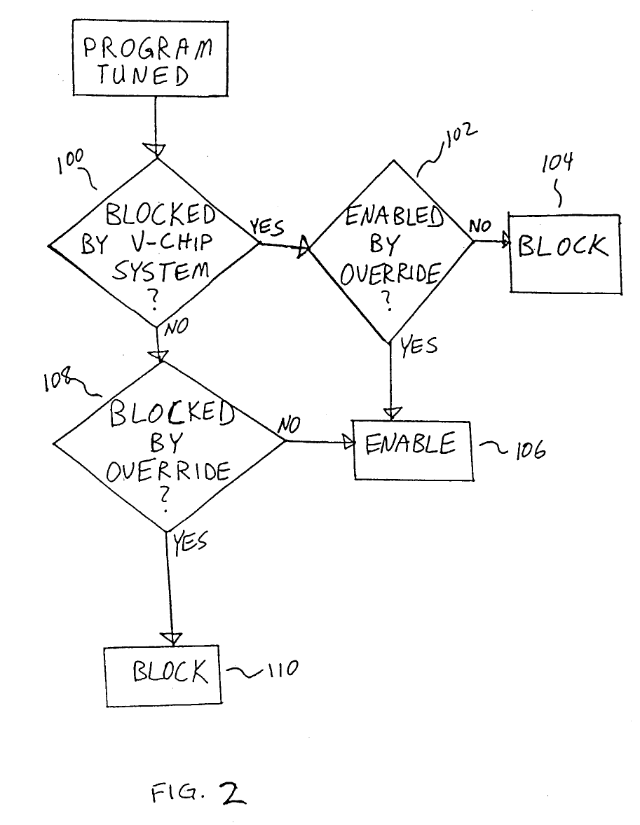

FIG. 2 illustrates the override arrangement of application Ser. No. 08/831,531. The possessor of unrestricted control unit 24 can either block a channel that transmits a program less objectionable than the desired level, or unblock a channel that transmits a program more objectionable than the desired level. Preferably, unrestricted control unit 24 has a unique unblock key and a unique unblock key that send commands to microprocessor 20 to execute the override. Since the unique keys are not found on restricted control unit 26, the possessor of restricted control unit 26 is not able to override. After the block or unblock key on unrestricted control unit 24 is pressed, the program to be overridden is identified by keying into a number keypad a compressed code (PLUS CODE™) representing channel, day, time, and length of the program as disclosed in U.S. Pat. No. 5,335,079, issued Aug. 2, 1996 for unattended future recording, followed by a key stroke that signifies the end of the PLUS CODE number. The '079 patent is incorporated herein fully by reference. After decoding the PLUS CODE, the channel, day, time, and length of the overridden program are stored in a time ordered stack in RAM and monitored as the recording stack disclosed in the '079 patent. The function, i.e., block or unblock is also stored with the channel, day, time, and length of the overridden program. If the unblock function was activated, at the time the overridden program occurs and tuner 12 is set to the channel of the overridden program, microprocessor 20 closes switch 14 to send the signal to monitor 16, regardless of the assigned rating of the program. If the block function was activated, at the time the overridden program occurs and tuner 12 is set to the channel of the overridden program, microprocessor 20 opens switch 14 to prevent the signal from being sent to monitor 16, regardless of the assigned rating of the program. In other words, when an override has been inputted for the program on the channel being selected by tuner 12, microprocessor 20 ignores the assigned rating of the program and does not assess whether the assigned rating is above or below the inputted parental control level. In either of these cases, the possessor of restricted control unit 26 is not able to change the ability to display the program on monitor 16.

To improve security, unrestricted control unit 24 could be configured to require that authorized users key a personal identification number (PIN) into a number key pad to activate the unit. The unit could remain activated for a prescribed period of time, after which the PIN would have to be reentered. Anyone could use restricted control unit 26.

The described override system could be used for parental control of a VCR. With reference to FIG. 1, a VCR is substituted for monitor 16 and switch 14 blocks a future program selected by unrestricted control unit 24 from transmission to the VCR when such program is telecast.

What is claimed is:

1. A parental control system comprising:
a first remote controller for issuing tuner commands having a first distinguishing characteristic;
a second remote controller for issuing tuner commands having a second distinguishing characteristic;
a television tuner;
an appliance connected to the tuner to use the signal from the tuner;
a microprocessor responsive to the commands of the remote controllers;
means for configuring the microprocessor to establish parental control standards;
means for configuring the microprocessor to detect the distinguishing characteristics;
means for configuring the microprocessor to detect a command that violates the parental control standards;
means for configuring the microprocessor to set the tuner when a command that violates the parental control standards has the first distinguishing characteristic and to ignore such a command that has the second distinguishing characteristic.
